(19) United States
(12) Patent Application Publication
(10) Pub. No.: US 2025/0223900 A1
(43) Pub. Date: Jul. 10, 2025

(54) BOREHOLE RESONANCE MODE FOR CEMENT EVALUATION USING MACHINE LEARNING

(71) Applicant: Halliburton Energy Services, Inc., Houston, TX (US)

(72) Inventors: Yao GE, Singapore (SG); Brenno Caetano Troca CABELLA, Rio de Janeiro (BR); Ruijia WANG, Singapore (SG)

(73) Assignee: Halliburton Energy Services, Inc., Houston, TX (US)

(21) Appl. No.: 18/406,635

(22) Filed: Jan. 8, 2024

(51) Int. Cl. E21B 47/005; G01V 1/50

(52) U.S. Cl. CPC E21B 47/005; G01V 1/50; E21B 2200/20

(57) ABSTRACT

Systems and methods are provided for evaluation of the cement bonding condition in a wellbore based on borehole resonance mode using machine learning. An example method can include transforming the return signal into a resonance signal based on feature extraction of the return signal, determining a segment of the resonance signal in a time domain, and determining, via a machine learning model, a predicted borehole cement bonding based on the segment of the resonance signal. The example method can further include generating a bonding log based on the predicted borehole cement bonding.

### TECHNICAL FIELD

The present disclosure generally relates to borehole resonance mode for cement evaluation using machine learning. For example, aspects of the present disclosure relate to a machine learning-based workflow for borehole resonance mode to evaluate a bonding condition behind a cemented casing.

### BACKGROUND

Wells can be drilled to access and produce hydrocarbons such as oil and gas from subterranean geological formations. Wellbore operations can include drilling operations, completion operations, fracturing operations, and production operations. Drilling operations may involve gathering information related to downhole geological formations of the wellbore. The information may be collected by wireline logging, logging while drilling (LWD), measurement while drilling (MWD), drill pipe conveyed logging, or coil tubing conveyed logging. For example, nuclear magnetic resonance (“NMR”) tools have been used to explore the subsurface based on the magnetic interactions with subsurface material in the field of logging.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1A is a schematic side-view of an example wireline logging environment, according to some examples of the present disclosure.

FIG. 1B is a schematic side-view of the example logging environment of FIG. 1A, according to some examples of the present disclosure.

FIG. 2 illustrates an example acoustic logging tool for through tubing cement evaluation (TTCE), in accordance with aspects of the present disclosure.

FIG. 3 illustrates an example process of generating a 1-dimensional bonding index using machine learning with resonance signal, according to some aspects of the disclosed technology.

FIG. 4 illustrates an example process of generating a 2-dimensional bonding map using machine learning with resonance signal, according to some aspects of the disclosed technology.

FIG. 5 illustrates an example machine learning training and prediction process of predicting borehole resonance bonding, according to some aspects of the disclosed technology.

FIGS. 6A-C illustrate an example process of a 1-dimensional feature extraction with baseline removal, according to some aspects of the disclosed technology.

FIGS. 7A-C illustrate an example 1-dimensional bonding index, which is generated using a machine learning algorithm with baseline removal, according to some aspects of the disclosed technology.

FIGS. 8A-C illustrate an example process of a 1-dimensional feature extraction without baseline removal, according to some aspects of the disclosed technology.

FIGS. 9A-C illustrate an example 1-dimensional bonding index, which is generated using a machine learning algorithm without baseline removal, according to some aspects of the disclosed technology.

FIG. 10 is a flowchart illustrating an example process of evaluating cement bonding condition based on borehole resonance signal using machine learning, according to some aspects of the disclosed technology.

FIG. 11 illustrates an example neural network, according to some aspects of the disclosed technology.

FIG. 12 illustrates an example computing device architecture which can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

For oil and gas exploration and production, a network of wells, installations and other conduits may be established by connecting sections of metal pipe together. For example, a well installation may be completed, in part, by lowering multiple sections of metal pipe (i.e., a conduit string) into a wellbore, and cementing the conduit string in place. In some well installations, multiple conduit strings are employed (e.g., a concentric multi-string arrangement) to allow for different operations related to well completion, production, or enhanced oil recovery (EOR) options.

At the end of a well installations' life, the well installation may be plugged and abandoned. Understanding cement bond integrity to a conduit string may be beneficial in determining how to plug the well installation. Generally, acoustics may be implemented by acoustic tools to form cement bond logs (CBLs). For example, acoustic logging tools may be used to emit an acoustic signal which may traverse through at least part of a conduit string to at least part of a casing. Reflected signals that are measured by the acoustic logging tool may be defined as return signals. Return signals may comprise reflections, guided waves, toll mode, resonance mode signal, etc., which can be analyzed to determine if the section of casing is fully bonded, or if a partially bonded section.

Traditional acoustic tools require the production tubing to be pulled out so that the signal may directly reach the casing through borehole fluid. Through-tubing cement evaluation (TTCE) can be challenging since acoustic devices (e.g., traditional CBL tools) do not have enough energy to penetrate the tubing with acoustic waves. Thus, the casing response may be too low compared to an overall signal, making it difficult to evaluate the cement property behind the casing. Additionally, the resonance mode signal (e.g., a borehole resonance mode/signal, which is generated when acoustic waves resonance within a well) can be sensitive to cement bonding with the casing in the presence of tubing.

Systems, apparatuses, processes (also referred to as methods), and computer-readable media (collectively referred to as “systems and techniques” or “system”) are described herein for evaluating a cement bonding condition based on a borehole resonance signal using machine learning. For example, the systems and techniques of the present disclosure can apply a machine learning method for borehole resonance signals to generate a 1-dimensional bonding index and/or 2-dimensional bonding map for evaluating the cement bonding condition in a wellbore.

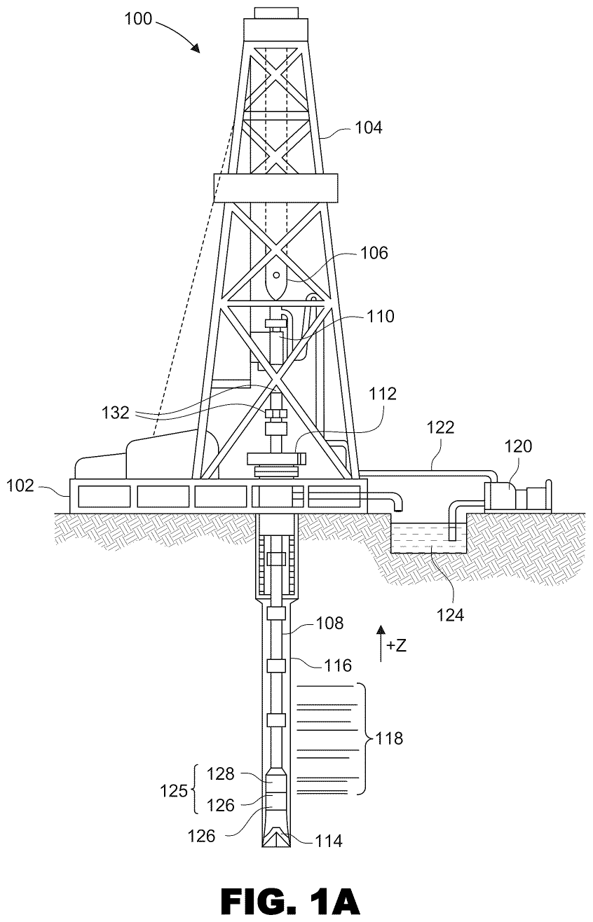

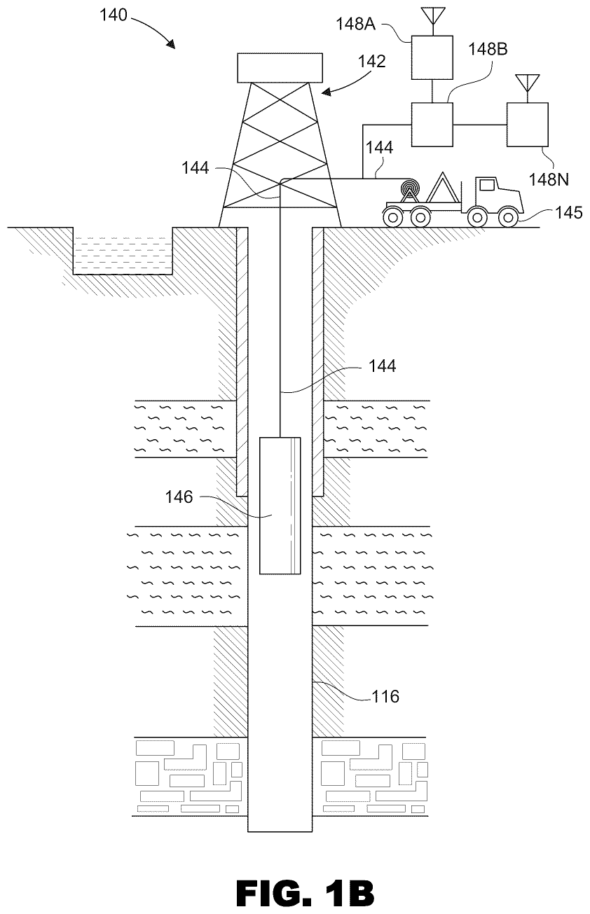

Examples of the systems and techniques described herein are illustrated in FIG. 1A through FIG. 12 and described below.

Turning now to FIG. 1A, a drilling arrangement is shown that exemplifies a Logging While Drilling (commonly abbreviated as LWD) configuration in a wellbore drilling scenario 100. Logging-While-Drilling typically incorporates sensors that acquire formation data. Specifically, the drilling arrangement shown in FIG. 1A can be used to gather formation data through an electromagnetic imager tool as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined.

FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As the both drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

Referring to FIG. 1B, an example system 140 is depicted for conducting downhole measurements after at least a portion of a wellbore has been drilled and the drill string removed from the well. A downhole tool can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via the wireline conveyance 144 to meet power requirements of the tool. For slickline or coiled tubing configurations, power can be supplied downhole with a battery or via a downhole generator.

Although FIGS. 1A and 1B depict specific borehole configurations, it should be understood that the present disclosure is suited for use in wellbores having other orientations including vertical wellbores, horizontal wellbores, slanted wellbores, multilateral wellbores, and the like. While FIGS. 1A and 1B depict an onshore operation, it should also be understood that the present disclosure is suited for use in offshore operations. Moreover, the present disclosure is not limited to the environments depicted in FIGS. 1A and 1B, and can also be used in other well operations such as, for example and without limitation, production tubing operations, jointed tubing operations, coiled tubing operations, combinations thereof, and/or the like.

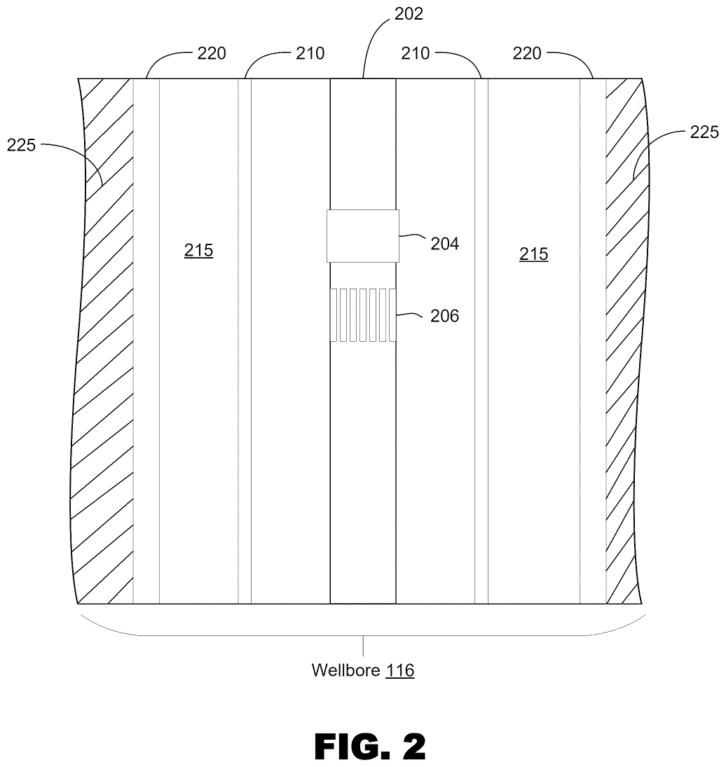

FIG. 2 illustrates an example acoustic logging tool 202 disposed in a wellbore (e.g., wellbore 116 as illustrated in FIG. 1) that is formed in a subsurface formation. In some cases, acoustic logging tool 202 can be used for through tubing cement evaluation (TTCE). The acoustic logging tool 202 can include logging tool 126 and/or tool body 146 of a downhole tool, which may be operated in example system 140 to log the wellbore. As shown, acoustic logging tool 202 is deployed within a well that is defined by a wellbore 116. The acoustic logging tool 202 is positioned with tubing 210, which is positioned down the wellbore 116 within casing 220. The casing 220 may be backed by any type of material, such as cement 225, formation, or a combination thereof.

In some examples, acoustic logging tool 202 comprises a transmitter 204 and a receiver 206. In some cases, one or more receivers 206 (e.g., an array of segmented receivers) may be positioned at selected distances (e.g., axial spacing) from transmitter 204. The configuration of acoustic logging tool 202 shown in FIG. 2 is merely illustrative and other configurations of acoustic logging tool 202 can be used with the present disclosure. In addition, acoustic logging tool 202 may include more than one transmitter 204 and more than one receiver 206.

In some aspects, transmitter 204 may transmit acoustic waves, which interact with the borehole structure such as tubing 210, borehole fluid 215, casing 220, and/or tool 202 itself. For example, transmitter 204 may transmit a signal (e.g., acoustic wave) through tubing 210, which may excite borehole fluid 215. The signal transmitted by transmitter 204 may lose energy as it passes through tubing 210. The signal may continue to resonate through borehole fluid 215 to casing 220 and interact with cement 225, which may be bonded to casing 220.

The returned signal can be then received by receiver 206. In some examples, the returned signal may comprise reflections, refractions, and/or a resonance, which is formed in late time. For example, the transmitted signal may interact with tubing 210, borehole fluid 215, casing 220, and/or cement 225, and be sensed, recorded, and/or measured by receiver 206 when returned. In some cases, the return signal can be processed to determine if cement 225 may be bonded to casing 220.

In some aspects, transmitter 204 may comprise any suitable acoustic source for generating acoustic waves, including, but not limited to, unipole, monopole, dipole, cross-dipole, quadrupole, or higher-order multipole sources. In some cases, transmitter 204 may include one or more transmitters 204 (e.g., segmented transmitters), which are combined to excite a mode corresponding to an irregular/arbitrary mode shape.

In some cases, receiver 206 can include segmented azimuthal receivers. For example, receiver 206 can include a number of receivers at different azimuthal positions circumferentially around acoustic logging tool 202. It should be noted that transmitter 204 and receiver 206 may be combined into a single element with the ability to both transmit acoustic waves and receive return acoustic waves, which may be identified as a transceiver.

While the configuration illustrated in FIG. 2 and other examples below refer to a TTCE, the systems and techniques of the present disclosure can be used for various downhole well logging applications (e.g., cemented borehole with or without the use of tubing).

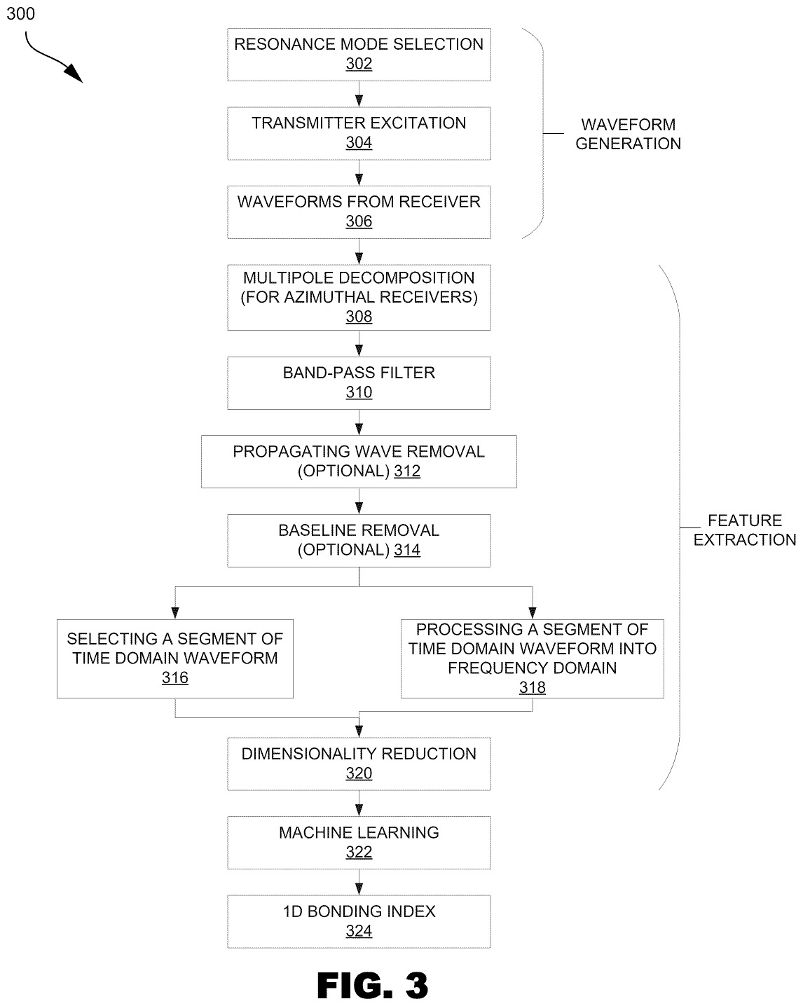

FIG. 3 illustrates an example process 300 of generating a 1-dimensional bonding index using machine learning for resonance signal. Although process 300 depicts a particular sequence of operations, the sequence may be altered without departing from the scope of the present disclosure. For example, some of the operations depicted may be performed in parallel or in a different sequence that does not materially affect the function of process 300. In other examples, different components of an example device or system that implements process 300 may perform functions at substantially the same time or in a specific sequence.

In some aspects, process 300 may start at step 302, which includes resonance mode selection. A resonance mode can be characterized by a frequency (e.g., frequency of a resonant frequency), a mode shape of a transmitter (e.g., monopole, dipole, or higher-order multipole acoustic source), modal decay rate, and/or attenuation rate. In some cases, a resonance mode may be selected based on an existing library, numerical simulation, or analytical solution.

In some examples, at step 304, process 300 may include transmitter excitation. For example, a transmitter (e.g., transmitter 204) is excited in accordance with the resonance mode (e.g., the frequency band and mode shape) that is selected at step 302. For example, if 4 kHz dipole is selected at step 302, a dipole source can be excited at frequencies at or near 4 kHz. The transmitter transmits an excitation and a signal (e.g., acoustic waves), which then interacts with the borehole.

At step 306, process 300 includes receiving waveforms from a receiver. For example, a return signal of the acoustic wave may be received by a receiver (e.g., receiver 206) such as an azimuthal receiver. The receiver may include a segmented piezoelectric tube, individual receiver, or azimuthal receivers, which may produce azimuthal variation of bonding behind casing (e.g., casing 220).

In some aspects, at step 308, process 300 includes multipole decomposition for azimuthal receivers. For example, the signal from the azimuthal array receiver may be decomposed to monopole, dipole, quadrupole, and higher order multipole response. For a monopole, dipole, or higher-order multipole receiver, the receiver may receive a signal of a specific multimode, which does not require decomposition.

In some examples, at step 310, process 300 includes applying a band-pass filter. For example, the decomposed waveform from step 308 can be filtered with a band-pass filter to extract the resonance signal of the selected mode. A band-pass filter can be used on the decomposed waveform to cover the resonance frequency of the selected borehole mode (e.g., resonance mode that is selected at step 302) and form a filtered time domain waveform within a certain bandwidth. For example, the frequency band may be determined by a pre-determined cement-sensitive resonance mode.

In some cases, at step 312, process 300 includes propagating wave removal. For example, propagating waves can be removed from the filtered time domain signal to remove non-resonance signal so that the remaining signal is a resonate signal. In some examples, propagating waves (e.g., guided waves or Stoneley waves) can be removed using a signal processing method such as tau-p transformation, F-K filter, Radon transform, frequency-wavenumber filtering, etc. In some cases, process 300 may skip step 312 of propagating wave removal and proceed to step 314.

In some aspects, at step 314, process 300 includes baseline removal. For example, a baseline can be removed by subtracting a baseline waveform from multipole decomposed waveforms from all depths. In some cases, the baseline signal can include a signal from the fully bonded depth. In some aspects, process 300 may skip step 314 of baseline removal and proceed to step 316.

In some examples, at step 316, process 300 includes selecting a segment of the time domain waveform (e.g., a resonance segment). For example, a segment of a waveform in a time domain can be selected, which can be provided to a machine learning algorithm as input. For example, a resonance segment occurs after a transient period where frequencies vary. As follows, a short-time Fourier transform or wavelet analysis can be used to select the resonance segment where the frequency components are constant over time.

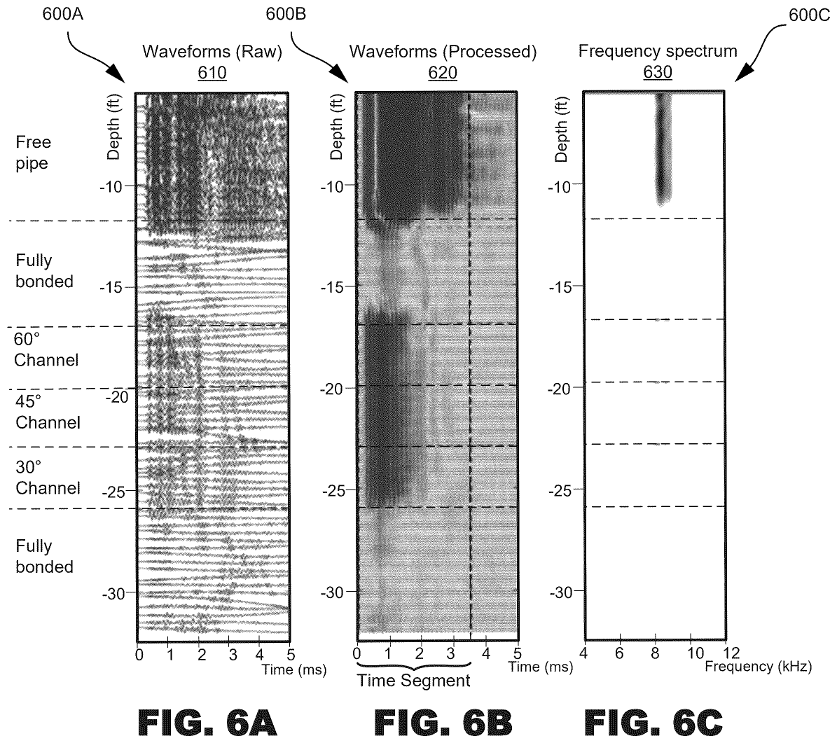

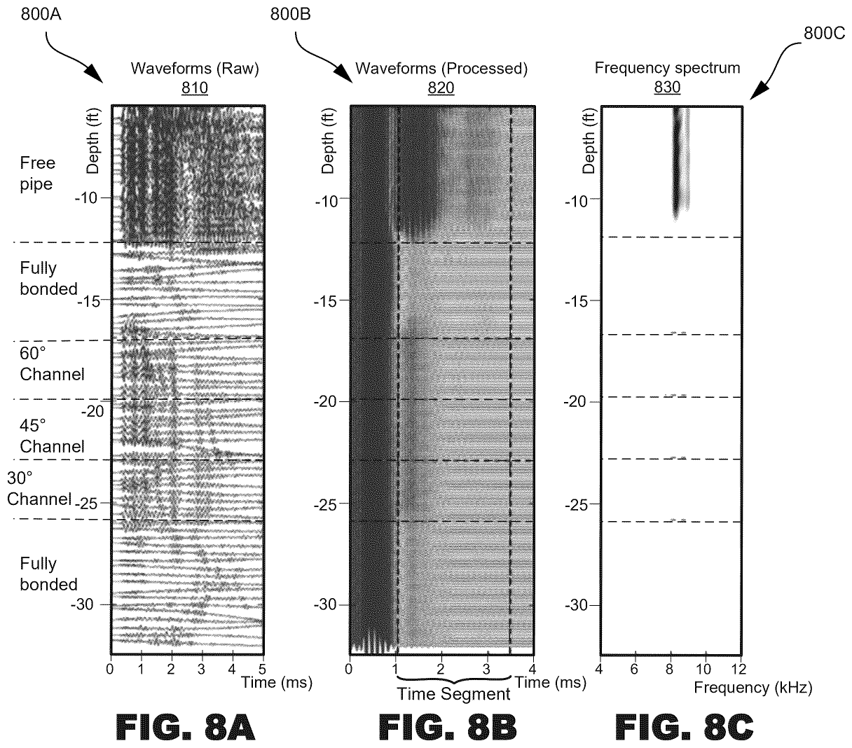

Alternatively, at step 318, process 300 includes processing a segment of the time domain waveform into a frequency domain. For example, a segment of time domain waveform can be transformed into a frequency domain. Examples of a frequency spectrum that is transformed from a time domain are illustrated in FIGS. 6C and 8C.

In some cases, at step 320, process 300 includes dimensionality reduction. For example, a number of dimensions or features in a signal dataset can be reduced such that the set's dimension of machine learning data can be reduced for efficiency. In some examples, waveforms, either in a time domain or a frequency domain, can be processed with a dimensional reduction method such as Principal Component Analysis (PCA), Factor Analysis (FA), Singular Value Decomposition (SVD), etc.

In some aspects, at step 322, process 300 includes applying a machine learning model. For example, the dimensionally reduced signal from step 320 can be fed into a machine learning model. Non-limiting examples of a machine learning model can include a regression model, an artificial neural network, a convolutional neural network, a decision tree algorithm, or a regularization algorithm. In some examples, a k-fold cross validation may be used within the training/test data split to compare the performance measured as Fi score, accuracy, a covariate-adjusted Receiver Operating Characteristic (AROC) curve, etc.

In some cases, process 300 can include providing one or more parameters associated with the resonance signal to a machine learning model. Examples of the parameters can include a geometry of a tubing (e.g., tubing 210), a geometry of casing (e.g., casing 220), eccentricity (e.g., tubing/tool offset divided by the annulus thickness between the tubing and casing), a modal frequency, etc. For example, tubing sizes, casing sizes, eccentricity directions, eccentricity amplitudes, a frequency bandwidth, a pulse frequency of a variable frequency drive (VFD), a shape and/or type of cement (e.g., cement 225), a type of annulus fluid (e.g., borehole fluid 215), or a combination thereof can be provided to a machine learning model.

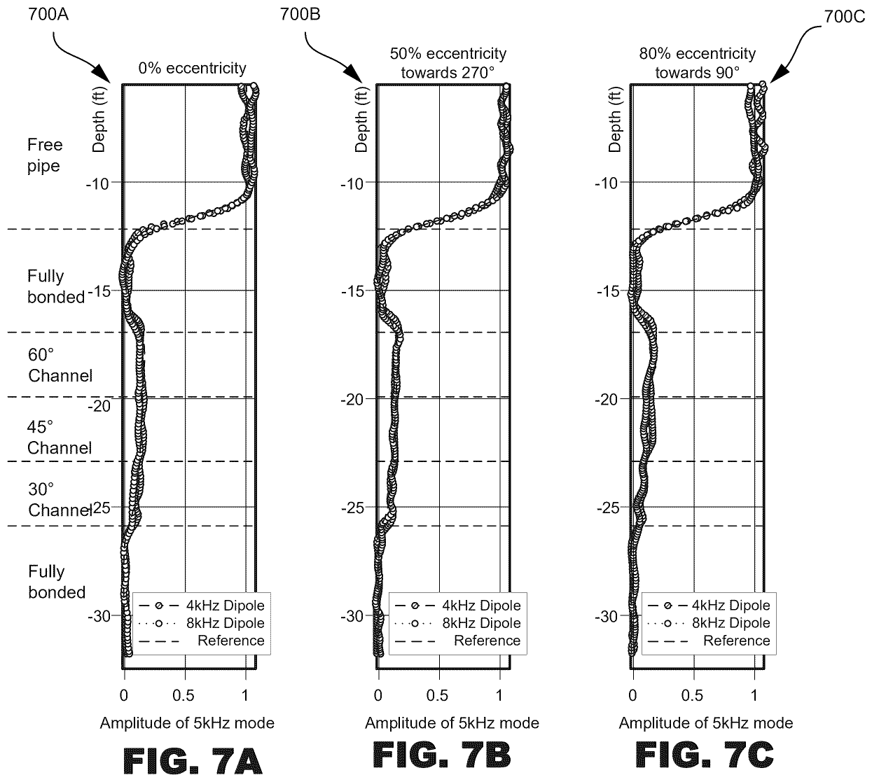

In some aspects, at step 324, process 300 includes generating a one-dimensional (1D) bonding index. For example, a machine learning model can output a 1D bonding index (e.g., 1D bonding index 700A-C as illustrated in FIGS. 7A-C).

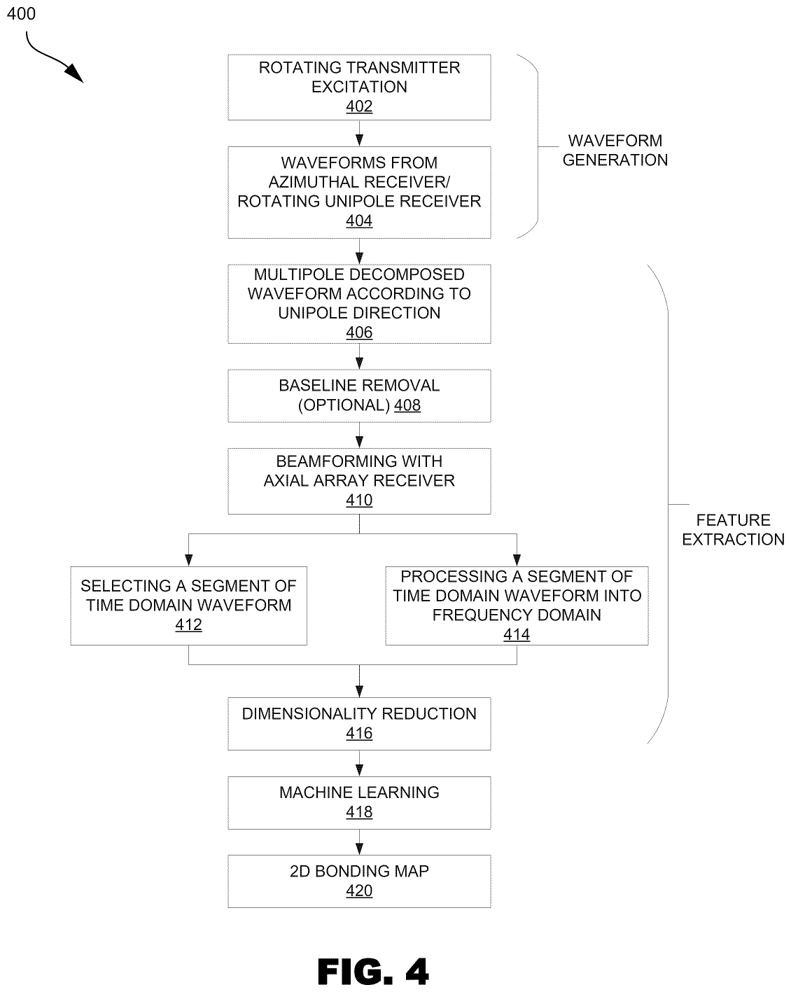

FIG. 4 illustrates an example process 400 of generating a 2-dimensional (2D) bonding map using machine learning for resonance signal. For example, a 2D bonding map can be predicted by a machine learning model when rotating transmitters and receivers are used for waveform generation. Although process 400 depicts a particular sequence of operations, the sequence may be altered without departing from the scope of the present disclosure. For example, some of the operations depicted may be performed in parallel or in a different sequence that does not materially affect the function of process 400. In other examples, different components of an example device or system that implements process 400 may perform functions at substantially the same time or in a specific sequence.

In some examples, process 400 may start at step 402, which includes rotating/rotatable transmitter excitation. For example, a rotating/rotatable transmitter (e.g., transmitter 204) can transmit excitation and signal (e.g., acoustic wave). The rotation of the transmitter may allow the signal to be received, at a receiver (e.g., receiver 206), in the azimuthal direction. For example, a rotating/rotatable transmitter can rotate for emission in different azimuthal directions. In other words, a rotating/rotatable transmitter can emit acoustic transmissions at different azimuthal directions such that there is at least one rotation. In some cases, the dipole component along any direction can be computed by summing the dipole response of each of the emissions at the specific direction.

In some aspects, the rotating transmitter can excite resonance mode with an order that is higher than monopole (e.g., dipole and higher). The higher-order resonance mode can have directivity, which can show different amplitude according to the channel direction. For example, if dipole mode has a directivity with 180° of ambiguity, it has the highest amplitude when the channel is along the dipole direction and lowest amplitude when the channel is orthogonal to the dipole direction. Combining multiple higher-order modes can generate a bonding log with azimuthal sensitivity, which allows the generation of a 2D bonding map.

In some cases, at step 404, process 400 includes receiving waveforms from an azimuthal receiver/rotating unipole receiver. For example, a return signal of the acoustic wave can be received by a receiver (e.g., receiver 206) such as an azimuthal receiver or rotating unipole receiver.

In some cases, at step 406, process 400 includes multipole decomposition based on a unipole direction. For example, the waveforms received at step 404 can be decomposed based on a unipole direction of the receiver.

In some examples, at step 408, process 400 includes baseline removal (similar to step 314). For example, a baseline can be removed by subtracting a baseline waveform from multipole decomposed waveforms from all depths. In some aspects, process 400 may skip step 408 of baseline removal and proceed to step 410.

In some aspects, at step 410, process 400 includes beamforming with axial array receiver(s). For example, for axial array receivers, a signal processing (e.g., beamforming or spatial filtering) can be used to improve the signal-to-noise ratio of received signals.

In some cases, at step 412, process 400 includes selecting a segment of time domain waveform (similar to step 316). For example, a segment of a waveform in a time domain can be selected, which can be provided to a machine learning algorithm as input.

Alternatively, at step 414, process 400 includes processing a segment of time domain waveform into frequency domain (similar to step 318). For example, a segment of time domain waveform can be transformed into a frequency domain.

In some examples, at step 416, process 400 includes dimensionality reduction (similar to step 320). For example, a number of dimensions or features in a signal dataset can be reduced such that the set's dimension of machine learning data can be reduced for efficiency.

In some aspects, at step 418, process 400 includes providing the input waveform to a machine learning model (similar to step 322). For example, the dimensionally reduced signal from step 416 can be fed into a machine learning model such as a regression model, an artificial neural network, a convolutional neural network, a decision tree algorithm, or a regularization algorithm.

In some cases, process 400 can include providing one or more parameters associated with the resonance signal to a machine learning model. Examples of the parameters can include a geometry of a tubing (e.g., tubing 210), a geometry of casing (e.g., casing 220), eccentricity (e.g., tubing/tool offset divided by the annulus thickness between the tubing and casing), etc. For example, tubing sizes, casing sizes, eccentricity directions, eccentricity amplitudes, or a combination thereof can be provided to a machine learning model.

In some cases, at step 420, process 400 includes generating a 2D bonding map (e.g., an output of the machine learning model from step 418). For example, a machine learning model can output, based on input waveform provided in step 418 along with one or more parameters, a 2D bonding map.

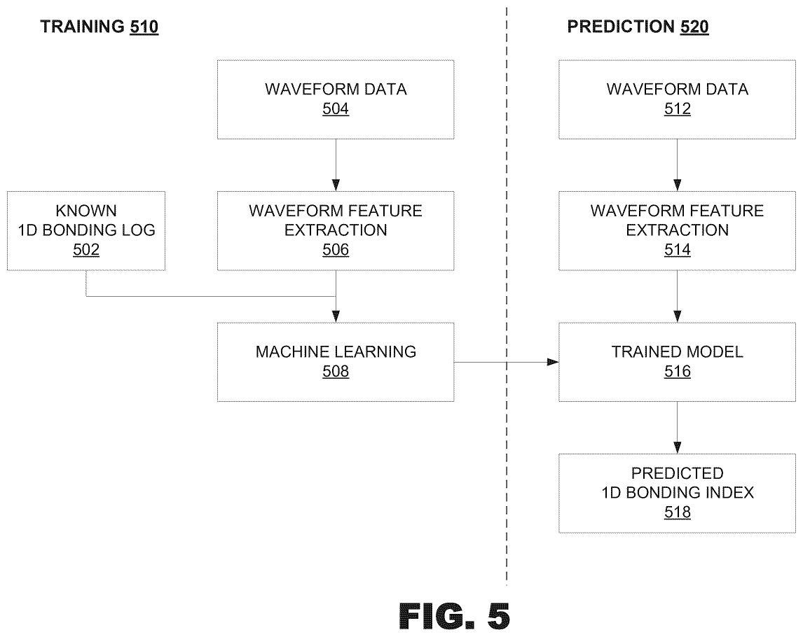

FIG. 5 illustrates an example machine learning training 510 and prediction 520 of predicting borehole resonance bonding. In training 510, waveform data 504 from a section of borehole with known bonding conditions (e.g., known 1D bonding log 502) can be processed with feature extraction 506 (e.g., feature extraction as illustrated in FIG. 2, which includes multipole decomposition 308, band-pass filter 310, propagating wave removal 312, baseline removal 314, etc.). The waveform is then processed with a machine learning algorithm 508 (e.g., neural network) with corresponding known 1D bonding log 502 to obtain a trained machine model 516.

In prediction 520, the waveform data 512 from a section with unknown bonding conditions can be processed with feature extraction 514 (e.g., feature extraction as illustrated in FIG. 3, which includes multipole decomposition 308, band-pass filter 310, propagating wave removal 312, baseline removal 314, etc.). It is then fed into the trained model 516 (e.g., trained neural network, machine learning 322 as illustrated in FIG. 3) to generate a predicted 1D bonding index 518.

FIGS. 6A-C illustrate an example process of a 1D extraction with baseline removal. The example 1D feature extraction process as illustrated in FIGS. 6A-C is for a signal from a wellbore with 4.5-inch tubing and 7⅝ inch casing. FIG. 6A illustrates raw waveform 600A, which is a decompressed waveform after multipole decomposition. FIG. 6B illustrates processed waveform 600B after baseline removal (e.g., baseline removal 314), applying band-pass filter (e.g., band-pass filter 310), and propagating wave removal (e.g., propagating wave removal 312). The waveform in the time segment of 0-3.5 ms in FIG. 6B can be processed into frequency spectrum 600C as illustrated in FIG. 6C. The frequency spectrum 600C shows the resonance mode at 9 kHz. The peaks in the frequency spectrum 600C can indicate the bonding between the casing (e.g., casing 220) and cement (e.g., cement 225) behind the casing.

FIGS. 7A-C illustrate an example 1D bonding index 700A, 700B, 700C, which is generated using a machine learning algorithm for a signal (in a wellbore with 4.5-inch tubing and 7⅝ inch casing). The signal is processed with baseline removal and collected at various eccentricities (e.g., various amplitudes and directions of eccentricity). The eccentricity can be measured in terms of percentage, which is calculated to be the tubing/tool offset divided by the annulus thickness between the tubing and casing. As follows, a 0% eccentricity means that the tubing/tool is concentric, while 100% eccentricity means that the tubing is touching the casing inner wall.

For example, 1D bonding index 700A in FIG. 7A represents dipole responses (e.g., for 4 kHz dipole and 8 kHz dipole) at 0% eccentricity. The 1D bonding index 700B in FIG. 7B represents dipole responses (e.g., for 4 kHz dipole and 8 kHz dipole) at 50% eccentricity towards 270°. The 1D bonding index 700C in FIG. 7C represents dipole responses (e.g., for 4 kHz dipole and 8 kHz dipole) at 80% eccentricity towards 90°.

FIGS. 8A-C illustrate an example process of a 1D extraction without baseline removal. The example 1D feature extraction process as illustrated in FIGS. 8A-C is for a signal from 4.5-inch tubing and 7⅝ inch casing. FIG. 8A illustrates raw waveform 800A, which is a decompressed waveform after multipole decomposition. FIG. 8B illustrates processed waveform 800B after applying band-pass filter (e.g., band-pass filter 310) and propagating wave removal (e.g., propagating wave removal 312) without baseline removal (e.g., baseline removal 314). The waveform in the time segment of 0-3.5 ms in FIG. 8B can be processed into frequency spectrum 800C as illustrated in FIG. 8C. The frequency spectrum 800C shows the resonance mode at 9 kHz.

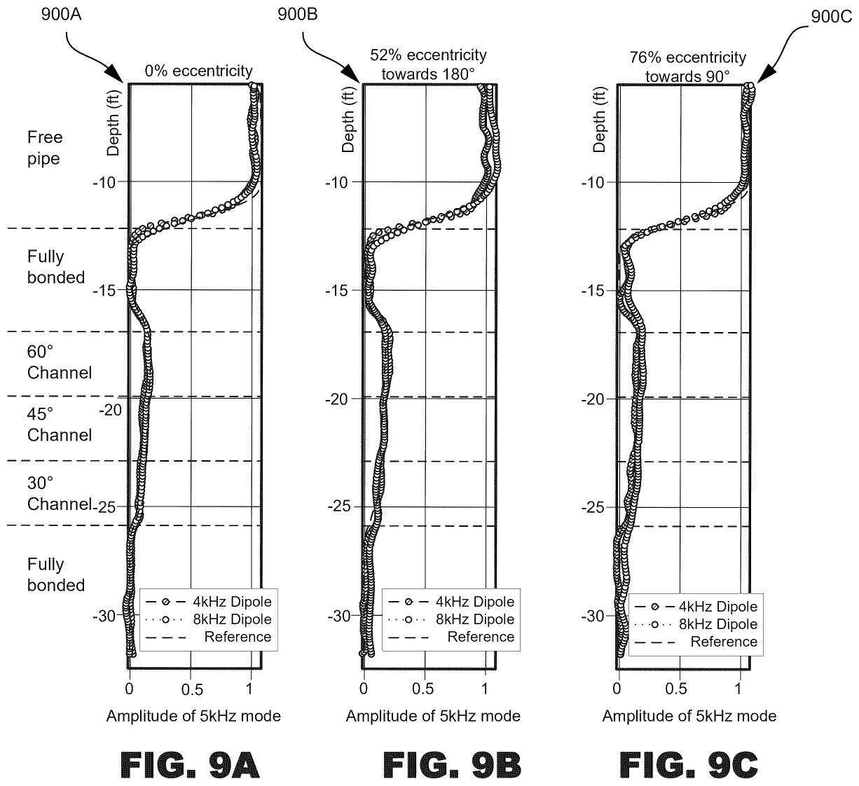

FIGS. 9A-C illustrate an example 1-dimensional bonding index, which is generated using a machine learning algorithm without baseline removal. For example, 1D bonding index 700A in FIG. 7A represents dipole responses (e.g., for 4 kHz dipole and 8 kHz dipole) at 0% eccentricity. The 1D bonding index 700B in FIG. 7B represents dipole responses (e.g., for 4 kHz dipole and 8 kHz dipole) at 50% eccentricity towards 270°. The 1D bonding index 700C in FIG. 7C represents dipole responses (e.g., for 4 kHz dipole and 8 kHz dipole) at 80% eccentricity towards 90°.

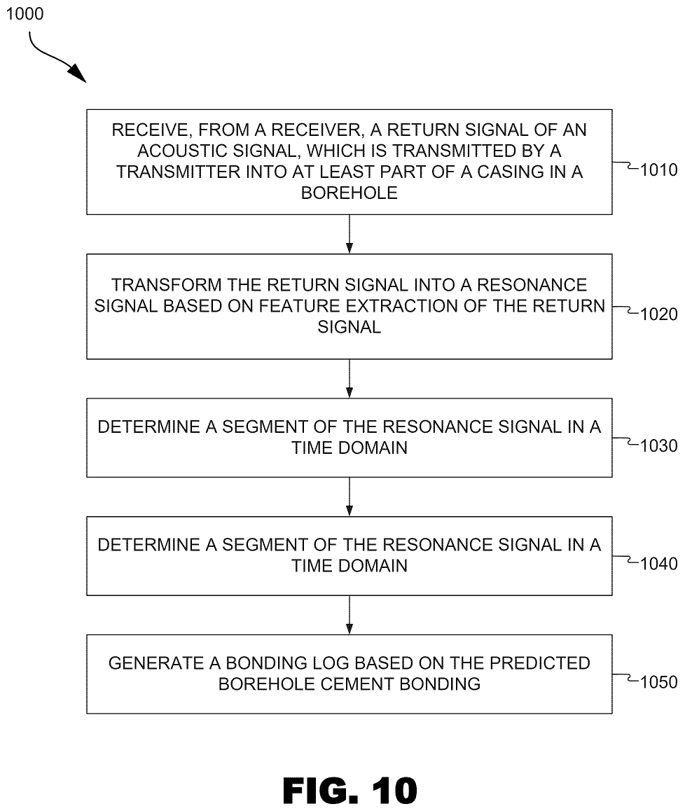

FIG. 10 is a flowchart illustrating an example process 1000 of an example process of evaluating cement bonding condition based on borehole resonance signal using machine learning. Although example process 1000 depicts a particular sequence of operations, the sequence may be altered without departing from the scope of the present disclosure. For example, some of the operations depicted may be performed in parallel or in a different sequence that does not materially affect the function of process 1000. In other examples, different components of an example device or system that implements process 1000 may perform functions at substantially the same time or in a specific sequence.

At step 1010, process 1000 includes receiving, from a receiver, a return signal of an acoustic signal, which is transmitted by a transmitter into at least part of a casing in a borehole. For example, an acoustic logging tool (e.g., a downhole tool, acoustic logging tool 202) can be conveyed in a tubing (e.g., tubing 210) positioned in a casing (e.g., casing 220) positioned around a wellbore (e.g., wellbore 116) such that there is an annular area between the casing and a wall of the wellbore into which cement (e.g., cement 225) is placed behind the casing.

In some examples, the acoustic logging tool (e.g., acoustic logging tool 202) may comprise a transmitter (e.g., transmitter 204) and a receiver (e.g., receiver 206) as illustrated in FIG. 2. For example, transmitter 204 may transmit an acoustic signal into at least part of casing 220, which then is received at receiver 206 as a return signal in wellbore 116.

At step 1020, process 1000 includes transforming the return signal into a resonance signal based on feature extraction of the return signal. For example, one or more receivers (e.g., receiver 206) can detect an acoustic response generated from the acoustic emission that passes through the tubing 210 and casing 220 and into cement 225. The return signal can be processed through feature extraction, which may include multipole decomposition 308, band-pass filter 310, propagating wave removal 312, baseline removal 314, etc.

At step 1030, process 1000 includes determining a segment of the resonance signal in a time domain. For example, a segment of the processed resonance signal in a time domain can be selected as input to a machine learning model.

At step 1040, process 1000 includes determining, via a machine learning model, a predicted borehole cement bonding based on the segment of the resonance signal. For example, a machine learning model (e.g., trained model 516) may output predicted 1D bonding index 518 (or 1D bonding box 324) as illustrated above.

At step 1050, process 1000 includes generating a bonding log based on the predicted borehole cement bonding. For example, based on the output of the machine learning model from step 1050, a bonding log (e.g., 1D bonding index or 2D bonding map) can be generated for evaluating the cement bonding conditions in a wellbore.

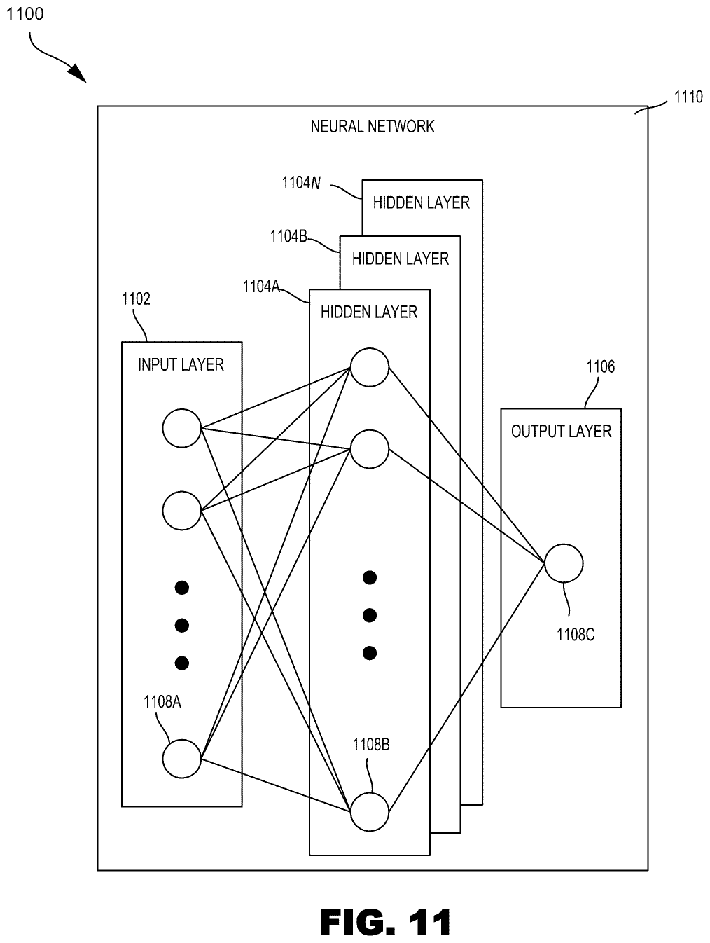

FIG. 11 illustrates an example of a neural network 1110 according to some examples of the present disclosure. The neural network 1110 can be used to implement any of the models described herein, such as machine learning model in machine learning 322 or machine learning 418, trained model 516, etc. As shown in this example, the neural network 1110 includes an input layer 1102 for processing input data. The neural network 1110 also includes hidden layers 1104A through 1104N (collectively “1104” hereinafter). The hidden layers 1104 can include n number of hidden layers, where n is an integer greater than or equal to one. The number of hidden layers can include as many layers as needed for a desired processing outcome and/or rendering intent. The neural network 1110 includes an output layer 1106 that provides an output resulting from the processing performed by the hidden layers 1104.

The neural network 1110 in this example is a multi-layer neural network of interconnected nodes. Each node can represent a piece of information. Information associated with the nodes is shared among the different layers and each layer retains information as information is processed. In some cases, the neural network 1110 can include a feed-forward neural network, in which case there are no feedback connections where outputs of the neural network are fed back into itself. In other cases, the neural network 1110 can include a recurrent neural network, which can have loops that allow information to be carried across nodes while reading in input.

Information can be exchanged between nodes through node-to-node interconnections between the various layers. Nodes of the input layer 1102 can activate a set of nodes in the first hidden layer 1104A. For example, as shown, each of the input nodes of the input layer 1102 is connected to each of the nodes of the first hidden layer 1104A. The nodes of the hidden layer 1104A can transform the information of each input node by applying activation functions to the information. The information derived from the transformation can then be passed to and can activate the nodes of the next hidden layer (e.g., 1104B), which can perform their own designated functions. Example functions include convolutional, up-sampling, data transformation, pooling, and/or any other suitable functions. The output of the hidden layer (e.g., 1104B) can then activate nodes of the next hidden layer (e.g., 1104N), and so on. The output of the last hidden layer can activate one or more nodes of the output layer 1106, at which point an output is provided. In some cases, while nodes (e.g., nodes 1108A, 1108B, 1108C) in the neural network 1110 are shown as having multiple output lines, a node has a single output and all lines shown as being output from a node represent the same output value.

In some cases, each node or interconnection between nodes can have a weight that is a set of parameters derived from training the neural network 1110. For example, an interconnection between nodes can represent a piece of information learned about the interconnected nodes. The interconnection can have a numeric weight that can be tuned (e.g., based on a training dataset), allowing the neural network 1110 to be adaptive to inputs and able to learn as more data is processed.

The neural network 1110 can be pre-trained to process the features from the data in the input layer 1102 using the different hidden layers 1104 in order to provide the output through the output layer 1106. In an example in which the neural network 1110 is used to output text answers, the neural network 1110 can be trained using training data that includes example question-answer pairs.

In some cases, the neural network 1110 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For example, the forward pass can include passing training data through the neural network 1110. The weights can be initially randomized before the neural network 1110 is trained. For a first training iteration for the neural network 1110, the output can include values that do not give preference to any particular class due to the weights being randomly selected at initialization. For example, if the output is a vector with probabilities for different outputs, the probability value for each of the different outputs may be equal or at least very similar (e.g., for ten possible outputs, each output may have a probability value of 0.1). With the initial weights, the neural network 1110 may be unable to determine low level features and thus may not make an accurate determination. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. The neural network 1110 can perform a backward pass by determining which inputs (weights) most contributed to the loss of the neural network 1110, and can adjust the weights so that the loss decreases and is eventually minimized.

A derivative of the loss with respect to the weights can be computed to determine the weights that contributed most to the loss of the neural network 1110. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 1110 can include any suitable neural or deep learning network. One example includes a convolutional neural network (CNN), which includes an input layer and an output layer, with multiple hidden layers between the input and out layers. The hidden layers of a CNN can include a series of convolutional, nonlinear, pooling (for downsampling), and fully connected layers. In other examples, the neural network 1110 can represent any other neural or deep learning network, such as a transformer network, an autoencoder, a deep belief nets (DBNs), a recurrent neural network (RNN), an LLM, etc.

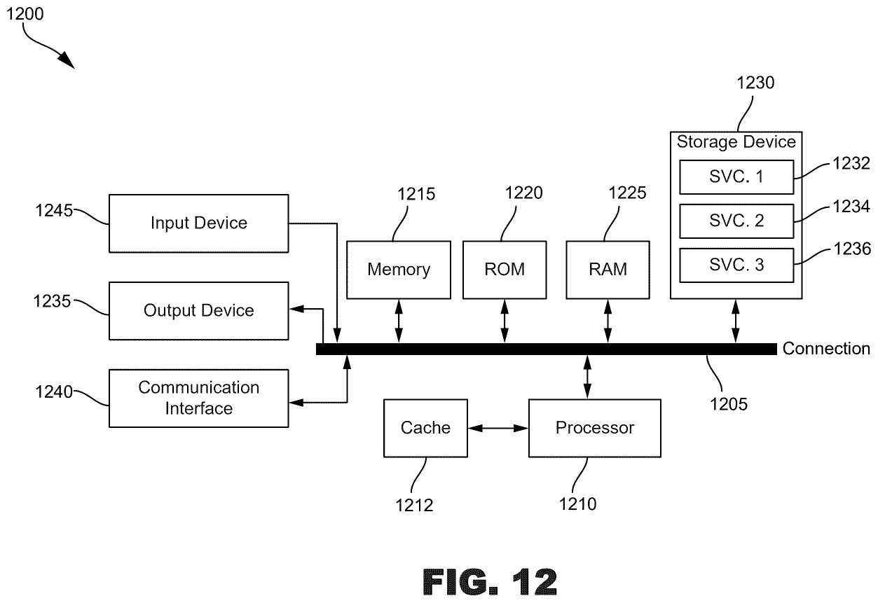

FIG. 12 illustrates an example computing device architecture 1200 which can be employed to perform various steps, methods, and techniques disclosed herein. Specifically, the techniques described herein can be implemented, at least in part, through the computing device architecture 1200 in an applicable computing device, such as logging tools 126 or acoustic logging tool 202. Further, the computing device can be configured to implement the techniques of evaluating cement bonding condition in wellbore as described herein (e.g., process 300, 400, etc.). The various implementations will be apparent to those of ordinary skill in the art when practicing the present technology. Persons of ordinary skill in the art will also readily appreciate that other system implementations or examples are possible.

The components of the computing device architecture 1200 are shown in electrical communication with each other using a connection 1205, such as a bus. The example computing device architecture 1200 includes a processing unit (CPU or processor) 1210 and a computing device connection 1205 that couples various computing device components including the computing device memory 1215, such as read only memory (ROM) 1220 and random-access memory (RAM) 1225, to the processor 1210.

The computing device architecture 1200 can include a cache of high-speed memory connected directly with, in close proximity to, or integrated as part of the processor 1210. The computing device architecture 1200 can copy data from the memory 1215 and/or the storage device 1230 to the cache 1212 for quick access by the processor 1210. In this way, the cache can provide a performance boost that avoids processor 1210 delays while waiting for data. These and other modules can control or be configured to control the processor 1210 to perform various actions. Other computing device memory 1215 may be available for use as well. The memory 1215 can include multiple different types of memory with different performance characteristics. The processor 1210 can include any general-purpose processor and a hardware or software service, such as service 1 1232, service 2 1234, and service 3 1236 stored in storage device 1230, configured to control the processor 1210 as well as a special-purpose processor where software instructions are incorporated into the processor design. The processor 1210 may be a self-contained system, containing multiple cores or processors, a bus, memory controller, cache, etc. A multi-core processor may be symmetric or asymmetric.

To enable user interaction with the computing device architecture 1200, an input device 1245 can represent any number of input mechanisms, such as a microphone for speech, a touch-sensitive screen for gesture or graphical input, keyboard, mouse, motion input, speech and so forth. An output device 1235 can also be one or more of a number of output mechanisms known to those of skill in the art, such as a display, projector, television, speaker device, etc. In some instances, multimodal computing devices can enable a user to provide multiple types of input to communicate with the computing device architecture 1200. The communications interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof. The storage device 1230 can include services 1232, 1234, 1236 for controlling the processor 1210. Other hardware or software modules are contemplated. The storage device 1230 can be connected to the computing device connection 1205. In one aspect, a hardware module that performs a particular function can include the software component stored in a computer-readable medium in connection with the necessary hardware components, such as the processor 1210, connection 1205, output device 1235, and so forth, to carry out the function.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A system comprising: a transmitter configured to transmit an acoustic signal into at least part of a casing in a borehole; a receiver configured to receive a return signal of the acoustic signal from the at least part of the casing in the borehole; a memory; and one or more processors coupled to the memory, the one or more processors being configured to: transform the return signal into a resonance signal based on feature extraction of the return signal; determine a segment of the resonance signal in a time domain; determine, via a machine learning model, a predicted borehole cement bonding based on the segment of the resonance signal; and generate a bonding log based on the predicted borehole cement bonding.
Aspect 2. The system of claim 1, wherein the one or more processors are further configured to: select a resonance mode that determines a resonance frequency of the acoustic signal that is transmitted by the transmitter.
Aspect 3. The system of claim 1, wherein the feature extraction comprises applying a filter to the return signal to form a filtered signal that covers a resonance frequency of the transmitter.
Aspect 4. The system of claim 1, wherein the receiver is an azimuthal receiver and the feature extraction comprises decomposing the return signal based on a multipole order of a mode shape.
Aspect 5. The system of claim 1, wherein the feature extraction comprises removing one or more propagating waves from the return signal.
Aspect 6. The system of claim 1, wherein the feature extraction comprises removing a baseline signal from the return signal.
Aspect 7. The system of claim 1, wherein the one or more processors are further configured to: transform the resonance signal from the time domain to a frequency domain.
Aspect 8. The system of claim 1, wherein the feature extraction comprises reducing a dimensionality of the resonance signal.
Aspect 9. The system of claim 1, wherein the predicted borehole cement bonding is determined, via the machine learning model, based on at least one of a geometry of the casing, a geometry of a tubing that is positioned in the casing, eccentricity of the tubing, a modal frequency, or a combination thereof.
Aspect 10. The system of claim 1, wherein the machine learning model comprises at least one of a regression model, an artificial neural network, a decision tree algorithm, or a regularization algorithm.
Aspect 11. A method comprising: receiving, from a receiver, a return signal of an acoustic signal, which is transmitted by a transmitter into at least part of a casing in a borehole; transforming the return signal into a resonance signal based on feature extraction of the return signal; determining a segment of the resonance signal in a time domain; determining, via a machine learning model, a predicted borehole cement bonding based on the segment of the resonance signal; and generating a bonding log based on the predicted borehole cement bonding.
Aspect 12. The method of claim 11, further comprising: selecting a resonance mode that determines a resonance frequency of the acoustic signal that is transmitted by the transmitter.
Aspect 13. The method of claim 11, wherein the feature extraction comprises applying a filter to the return signal to form a filtered signal that covers a resonance frequency of the transmitter.
Aspect 14. The method of claim 11, wherein the receiver is an azimuthal receiver and the feature extraction comprises decomposing the return signal based on a multipole order of a mode shape.
Aspect 15. The method of claim 11, wherein the feature extraction comprises removing one or more propagating waves from the return signal.
Aspect 16. The method of claim 11, wherein the feature extraction comprises removing a baseline signal from the return signal.
Aspect 17. The method of claim 11, further comprising: transforming the resonance signal from the time domain to a frequency domain.
Aspect 18. The method of claim 11, wherein the feature extraction comprises reducing a dimensionality of the resonance signal.
Aspect 19. The method of claim 11, wherein the predicted borehole cement bonding is determined, via the machine learning model, based on at least one of a geometry of the casing, a geometry of a tubing that is positioned in the casing, eccentricity of the tubing, a modal frequency, or a combination thereof.
Aspect 20. A non-transitory computer-readable medium having stored thereon instructions which, when executed by one or more processors, cause the one or more processors to: receive a return signal of an acoustic signal, which is transmitted by a transmitter into at least part of a casing in a borehole; transform the return signal into a resonance signal based on feature extraction of the return signal; determine a segment of the resonance signal in a time domain; determine, via a machine learning model, a predicted borehole cement bonding based on the segment of the resonance signal; and generate a bonding log based on the predicted borehole cement bonding.

What is claimed is:

1. A system comprising:
a transmitter configured to transmit an acoustic signal into at least part of a casing in a borehole;
a receiver configured to receive a return signal of the acoustic signal from the at least part of the casing in the borehole;
a memory; and
one or more processors coupled to the memory, the one or more processors being configured to:
transform the return signal into a resonance signal based on feature extraction of the return signal;
determine a segment of the resonance signal in a time domain;
determine, via a machine learning model, a predicted borehole cement bonding based on the segment of the resonance signal; and
generate a bonding log based on the predicted borehole cement bonding.

2. The system of claim 1, wherein the one or more processors are further configured to:
select a resonance mode that determines a resonance frequency of the acoustic signal that is transmitted by the transmitter.

3. The system of claim 1, wherein the feature extraction comprises applying a filter to the return signal to form a filtered signal that covers a resonance frequency of the transmitter.

4. The system of claim 1, wherein the receiver is an azimuthal receiver and the feature extraction comprises decomposing the return signal based on a multipole order of a mode shape.

5. The system of claim 1, wherein the feature extraction comprises removing one or more propagating waves from the return signal.

6. The system of claim 1, wherein the feature extraction comprises removing a baseline signal from the return signal.

7. The system of claim 1, wherein the one or more processors are further configured to:
transform the resonance signal from the time domain to a frequency domain.

8. The system of claim 1, wherein the feature extraction comprises reducing a dimensionality of the resonance signal.

9. The system of claim 1, wherein the predicted borehole cement bonding is determined, via the machine learning model, based on at least one of a geometry of the casing, a geometry of a tubing that is positioned in the casing, eccentricity of the tubing, a modal frequency, or a combination thereof.

10. The system of claim 1, wherein the machine learning model comprises at least one of a regression model, an artificial neural network, a decision tree algorithm, or a regularization algorithm.

11. A method comprising:
receiving, from a receiver, a return signal of an acoustic signal, which is transmitted by a transmitter into at least part of a casing in a borehole;
transforming the return signal into a resonance signal based on feature extraction of the return signal;
determining a segment of the resonance signal in a time domain;
determining, via a machine learning model, a predicted borehole cement bonding based on the segment of the resonance signal; and
generating a bonding log based on the predicted borehole cement bonding.

12. The method of claim 11, further comprising:
selecting a resonance mode that determines a resonance frequency of the acoustic signal that is transmitted by the transmitter.

13. The method of claim 11, wherein the feature extraction comprises applying a filter to the return signal to form a filtered signal that covers a resonance frequency of the transmitter.

14. The method of claim 11, wherein the receiver is an azimuthal receiver and the feature extraction comprises decomposing the return signal based on a multipole order of a mode shape.

15. The method of claim 11, wherein the feature extraction comprises removing one or more propagating waves from the return signal.

16. The method of claim 11, wherein the feature extraction comprises removing a baseline signal from the return signal.

17. The method of claim 11, further comprising:
transforming the resonance signal from the time domain to a frequency domain.

18. The method of claim 11, wherein the feature extraction comprises reducing a dimensionality of the resonance signal.

19. The method of claim 11, wherein the predicted borehole cement bonding is determined, via the machine learning model, based on at least one of a geometry of the casing, a geometry of a tubing that is positioned in the casing, eccentricity of the tubing, a modal frequency, or a combination thereof.

20. A non-transitory computer-readable medium having stored thereon instructions which, when executed by one or more processors, cause the one or more processors to:
receive a return signal of an acoustic signal, which is transmitted by a transmitter into at least part of a casing in a borehole;
transform the return signal into a resonance signal based on feature extraction of the return signal;
determine a segment of the resonance signal in a time domain;
determine, via a machine learning model, a predicted borehole cement bonding based on the segment of the resonance signal; and
generate a bonding log based on the predicted borehole cement bonding.
